(19) United States
(12) Patent Application Publication
(10) Pub. No.: US 2015/0033146 A1
(43) Pub. Date: Jan. 29, 2015

(54) AUTOMATIC DETECTION AND MAGNIFICATION OF FOCUS REGION FOR CONTENT SHARED DURING AN ONLINE MEETING SESSION

(71) Applicant: Cisco Technology, Inc., San Jose, CA (US)

(72) Inventors: Yuan Wu, SUZHOU (CN); Qian Wang, SUZHOU (CN); Shibin Yang, SUZHOU (CN); Yunfeng Guan, SUZHOU (CN)

(73) Assignee: Cisco Technology, Inc., San Jose, CA (US)

(21) Appl. No.: 13/950,408

(22) Filed: Jul. 25, 2013

(51) Int. Cl. H04L 29/06

(52) U.S. Cl. CPC H04L 65/403
USPC 715/753

(57) ABSTRACT

Techniques are described herein for a plurality of computing devices engaged in an online meeting, where one of the computing devices is designated as a presenter and shared content is provided from the presenter engaged in the online meeting. A detection is made regarding whether a display icon located for the shared content and controlled via an icon navigation device at the presenter has moved. In response to a detection that the display icon has moved, a focus region is determined that corresponds with movements of the display icon, where the focus region includes a defined smaller area of the shared content in relation to the entire area. An indication is provided to automatically modify the shared content so as to magnify a view of the focus region at one or more computing devices engaged in the online meeting.

### TECHNICAL FIELD

The present disclosure relates to sharing of content during online meetings.

### BACKGROUND

The use of online meetings has become more common due to distances between people in business and other environments as well as advances in video and communications technologies. In addition, with the increased use of mobile devices, more people take advantage of communication technologies integrated with the mobile devices to engage in online meetings with the use of such mobile devices, including the sharing of files and other content during such online meetings.

However, given the smaller sizes of mobile devices, and the corresponding smaller screen sizes (e.g., in comparison to the screen size of a laptop or PC), it can be difficult at times for a user of a mobile device to follow details of content while it is being shared by a presenter within an online meeting. For example, in a scenario in which a presenter is sharing a file such as a word processing document, a spreadsheet, a slide presentation, etc., the content may be too small on the screen of a mobile device for a user to visualize and understand the content currently being presented. In order for a user of a mobile device to fully appreciate the shared content, the user may need to use a magnification or zoom function at times. This makes the mobile device user experience during the online meeting more difficult, particularly during changes in content being presented during the meeting.

### BRIEF DESCRIPTION OF THE DRAWINGS

FIG. 1 is a schematic block diagram of an example system that facilitates online meetings between client devices that are hosted by one or more servers.

FIG. 2 is a schematic block diagram of an example client device that engages in an online meeting with other client devices via the system of FIG. 1, where the client device can be configured to track focus regions of content when the user of the client device is a presenter of an online meeting.

FIG. 3 is a schematic block diagram of an example embodiment of a server that hosts online meeting for the system of FIG. 1.

FIGS. 4A and 4B depict an example embodiment of a mobile device engaging in an online meeting including sharing of content by another device within the system of FIG. 1.

FIG. 5 is a flow chart depicting an example process for automatically detecting and magnifying a focus region for mobile devices engaged in an online meeting in which content is shared using the system of FIG. 1 and based upon tracking movements of a navigational icon on a display of a presenter of the content.

FIG. 6 depicts an example embodiment of shared content for an online meeting that is determined to not include text, including defined focus regions within the shared content.

FIG. 7 depicts an example embodiment of shared content for an online meeting that is determined to include text, including defined focus regions within the shared content.

FIGS. 8-10 depict example embodiments of shared content and showing different example embodiments of how navigator detection can be implemented to determine focus regions to magnify in accordance with techniques described herein.

### DESCRIPTION OF EXAMPLE EMBODIMENTS

### Overview

Techniques are described herein for a plurality of computing devices engaged in an online meeting, where one of the computing devices is designated as a presenter and shared content is provided from the presenter to at least one other computing device engaged in the online meeting. A detection is made regarding whether a display icon located within an entire area of the shared content and controlled via an icon navigation device at the presenter has moved from a first position to at least one moved position. In response to a detection that the display icon has moved to the at least one moved position, a focus region is determined that corresponds with movements of the display icon, where the focus region comprises a defined smaller area of the shared content in relation to the entire area and encompasses the at least one moved position. An indication is provided to automatically modify the shared content so as to magnify a view of the focus region at one or more computing devices engaged in the online meeting.

### Example Embodiments

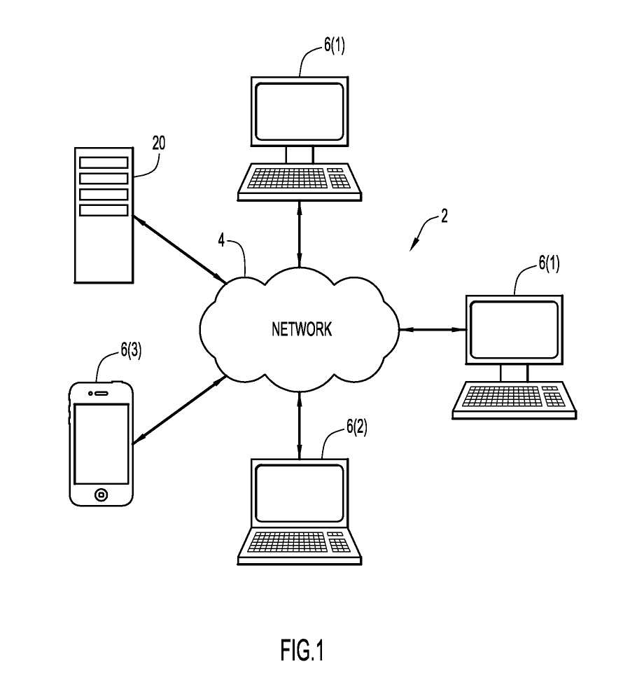

An example embodiment of a system that supports online meetings and other types of communications and sharing or exchange of content between client devices, including PC client devices and mobile client devices, is depicted in the schematic diagram of FIG. 1. As used herein, the term “online meeting” or “online meeting session” refers to a communication between at least two client devices that can include audio and/or video content (e.g., a video meeting, where images of users at different client devices are captured and provided to other client devices as part of the communication) as well as the sharing of content (e.g., sharing of files or documents, such as word processing documents, spreadsheet documents, slide presentations, etc., sharing of images and the sharing of any other types of content). In an online meeting session, content is typically shared by a user at a client device that is designated as a presenter within the online meeting session (where the presenter designation can switch between client devices during the ongoing online meeting) as described herein.

Referring to FIG. 1, a system 2 comprises a network 4 that facilitates communications and exchange of communications and content (e.g., sharing of documents or files, images, video, etc.) between client devices 6 via one or more host server devices 20. While three client devices 6 and one server device 20 are shown, this is for example purposes only, and it is noted that the network 4 can support communications and exchange of content between any suitable number of client devices and host server devices. Examples of types of networks that can be utilized within system 2 include, without limitation, any one or more of local or wide area networks, Internet Protocol (IP) networks such as intranet or internet networks, telephone networks (e.g., public switched telephone networks), wireless or mobile phone or cellular networks, and any suitable combinations thereof.

As shown in the example embodiment of FIG. 1, different client devices 6 may be engaged in an online meeting session at any given time. For example, client devices can include any suitable computing device or computing devices, such as personal computer (PC) devices, such as stationary (e.g., desktop) computers (e.g., client devices 6-1) and laptops (e.g., client device 6-2), or any other type of mobile computing device such as note pads, tablets, personal data assistant (PDA) devices, and other portable media player devices, and cell phones (e.g., smartphones, such as client device 6-3). Each of the client devices include suitable processors, input and output (I/O) devices, memory and software as described herein to facilitate communications with other client devices over the network 4 and via host server(s) 20, including engaging in online meetings (e.g., video meetings) with sharing of content during such meetings.

Suitable server devices 20 can be any suitable types of stationary or other types of computing devices capable of hosting and managing online meetings and also, optionally, other types of communication sessions between client devices 6 (e.g., email, instant messaging or SMS communications, posting of content in blogs or other virtual environments, support of chat rooms, communities or other forms of social networking platforms).

The client devices and servers can utilize any suitable operating systems (e.g., Android, Windows, Mac OS, Symbian OS, RIM Blackberry OS, Linux, etc.) to facilitate interaction, communications and sharing of content between client devices 6 over the network 4. In addition, the techniques described herein for enhancing the experience particularly for users of mobile devices during sharing of content in an online meeting can be implemented utilizing any suitable types of commercial software products and associated services that support such communications and sharing of content between client devices. Some examples of software products and associated services with which the techniques described herein can be integrated include, without limitation, WebEx (Cisco Systems, Inc.) and LotusLive (IBM Corporation).

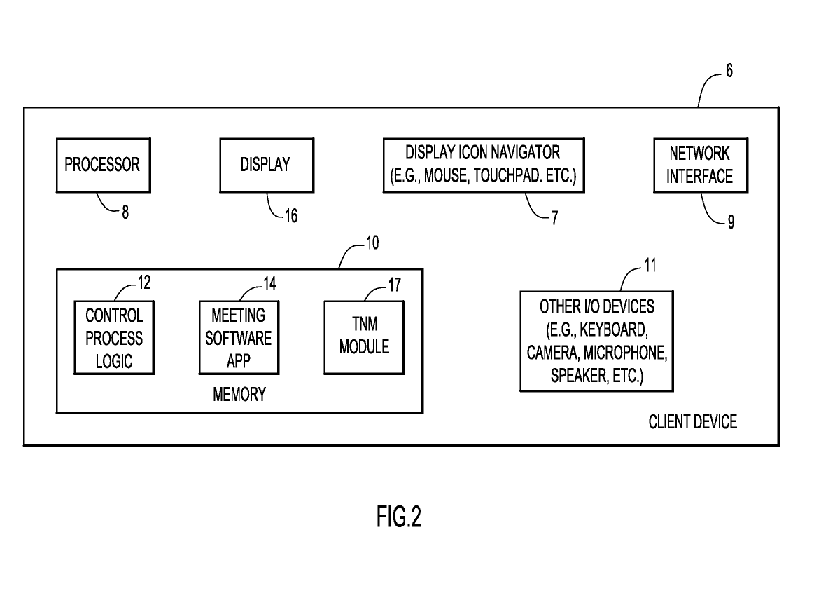

An example embodiment of a client device 6 is depicted in the block diagram of FIG. 2. In particular, the client device 6 includes a processor 8, a network interface 9, a memory 10, and a display 16 (e.g., LCD or any other suitable type of display screen for displaying video content, images, documents or files and any other types of content). The client device also includes a display icon navigation controller or navigator 7, which generally refers to any conventional or other suitable device that facilitates movement or navigation of a pointer, a cursor or other suitable icon in the display 16 of the client device so as to facilitate highlighting of displayed content within a document or file, input of content within the document or file, or engaging in any other interactive features associated with the document or file. Some examples of a navigator that can be used with the client device 6 include, without limitation, a mouse device (e.g., for PC devices), a touch pad or touch screen (e.g., for laptops, tablets, PDAs or other mobile devices, etc.). It is noted that the navigator 7 can be integrated with the client device 6 (e.g., as a touch pad or touch screen) or as a peripheral device that is linked (e.g., hardwire or wireless link) with the client device 6 (e.g., a mouse device). The client device 6 can further include any other suitable input and/or output (I/O) devices (depicted generally as box 11) including, without limitation, a keyboard, a camera, a microphone, speaker(s), etc.

The network interface 9 of the client device 6 can be, for example, one or more of an Ethernet interface card or switch, a modem, a router or any other suitable hardware device that facilitates a wireless and/or hardwire connection over the network 4 with one or more server devices 20 and other client devices 6, where the network interface unit can be integrated within the device or a peripheral that connects with the device.

The memory 10 of the client device 6 may comprise read only memory (ROM), random access memory (RAM), magnetic disk storage media devices, optical storage media devices, flash memory devices, electrical, optical, or other physical/tangible memory storage devices, and any combinations thereof. The processor 8 can comprise at least one microprocessor that executes control process logic instructions 12 stored within memory 10 including operational instructions and software applications stored within such memory (e.g., operation of a TNM module 17 as described herein). Thus, in general, the memory 10 may comprise one or more tangible (non-transitory) computer readable storage media (e.g., a memory device) encoded with software comprising computer executable instructions and when the software is executed (by the processor 8) it is operable to perform the operations described herein in connection with the TNM module 17 for automatically magnifying a focus region for content shared during an online meeting. A focus region refers to a defined area that is smaller than and within the entire area that defines the shared content.

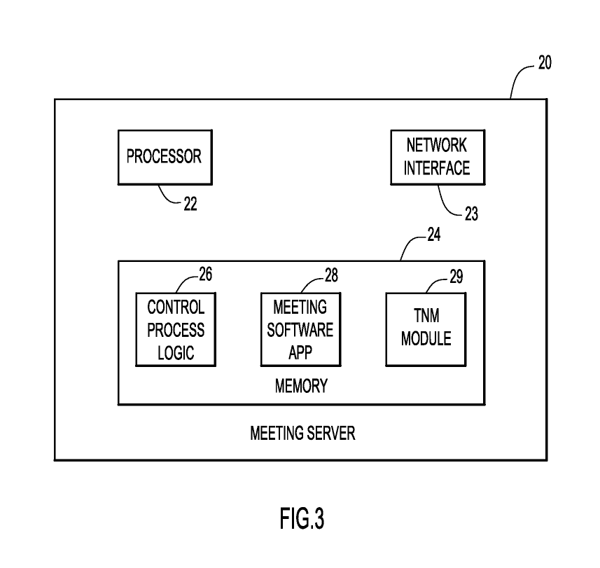

An example embodiment of a meeting server 20 that can be used in the system 2 of FIG. 1 is depicted in the block diagram of FIG. 3. Server 20 includes a processor 20, a network interface 23, and a memory 24 including control process logic 26 and other suitable software for performing operations in relation to the techniques described herein. The processor 20, network interface 23 and memory 24 for the meeting server 20 can be of the same or similar types and have the same or similar functionalities as previously described herein in relation to the client device 6.

The memory 10 of each client device 6 includes a meeting software application module 14 that comprises one or more software applications that facilitate online meetings and/or other types of communications with other client devices 6 over the network, where the online meetings are hosted by one or more host meeting servers 20. Each meeting server 20 also includes a meeting software application module that facilitates hosting by the meeting server 20 of online meetings, including sharing of content between client devices 6, as well as other types of communication over a suitable software platform (e.g., via a Cisco WebEx software platform, a LotusLive software platform or any other suitable software platform). Memory 10 of one or more client devices 6 also includes a tracking navigator motion (TNM) module 17 comprising one or more suitable software applications that are configured to track and record motions of the icon by the navigator 7 in relation to the display 16 when the client device 6 is designated as a presenter and content is being shared during an online meeting session. The memory 24 of one or more meeting servers 20 can also optionally include a TNM module 29 comprising one or more suitable software applications that receives navigator motion tracking information from a client device 6 designated as a presenter and processes such information as described herein such that certain other client devices 6 engaged in an ongoing online meeting session provide a magnification of a focus region associated with the navigator motion tracking information.

As previously noted herein, mobile client devices, such as PDAs and cellular phones (e.g., smart phones), are being used more frequently by users to engage in online meetings. Due to the smaller display screen window size of such mobile client devices (e.g., in relation to a PC client device, such as a desktop computer or a laptop computer), it can be difficult to view content that is being shared by a presenter within an online meeting session (e.g., the sharing of a word processing document, a slide presentation, a spreadsheet document, etc.). The user of the mobile client device has the option to enlarge or magnify a portion of the display (e.g., via conventional touch screen magnification or zoom techniques, such as finger slide or swipe techniques, etc.) to render it easier to view. However, such manual magnification techniques can be distracting to the user when trying to engage in the ongoing online meeting. The techniques described herein provide automatic enlargement or magnification of a focus region of shared content for mobile client devices (or any other client device authorizing such feature) within an ongoing online meeting within based upon detection of display icon navigator motions by the presenter of the content.

In particular, the TNM module 17 provides one or more algorithms, via the one or more software applications of the module 17, that detect motion of an icon (e.g., pointer, cursor, etc.) based upon inputs from the display icon navigator 7 at the client device 6 currently designated as the presenter within the online meeting session and in relation to content that is being shared. Based upon such motion detection, a focus region within the shared content is defined (where the focus region defines an area within the shared content that is smaller than the entire area of the shared content), and this focus region (or information regarding the focus region) is provided, via communications over the network 4, to other client devices 6 engaged in the online meeting session. The focus region information can be used to automatically enlarge or magnify the focus region within the shared content at the client device 6.

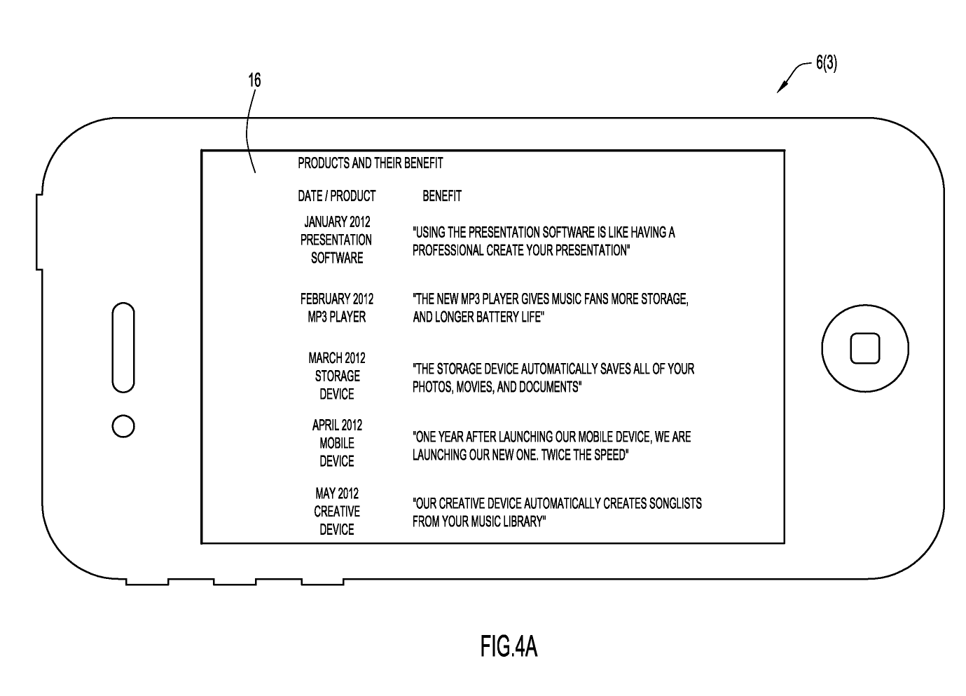

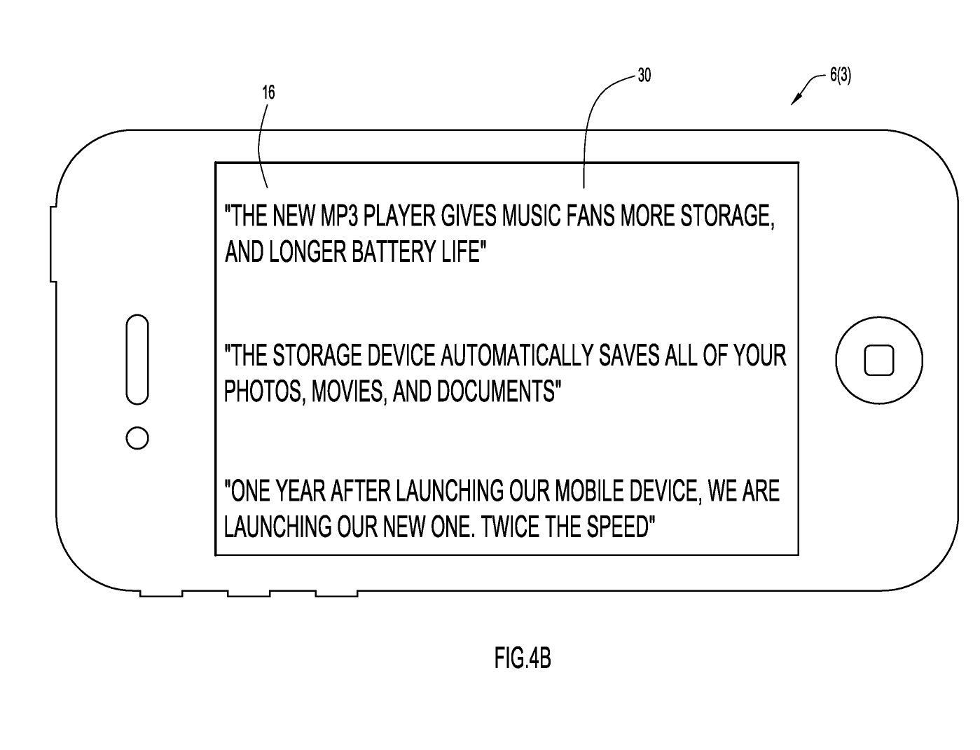

An example embodiment showing how automatic magnification of a detected focus region for shared content within an online meeting session is viewed at a mobile client device 6-3 (e.g., a cellular phone) is depicted in FIGS. 4A and 4B. In FIG. 4A, text content (e.g., from a word processing document) is being shared within an online meeting session. The content may be difficult to view on the small display screen 16 of the mobile client device 6-3. An automatic magnification of a detected focus region 30 of the shared content, when displayed by the display screen 16 of the mobile client device 6-3, becomes more clearly legible and easier to view by the user of the device 6-3.

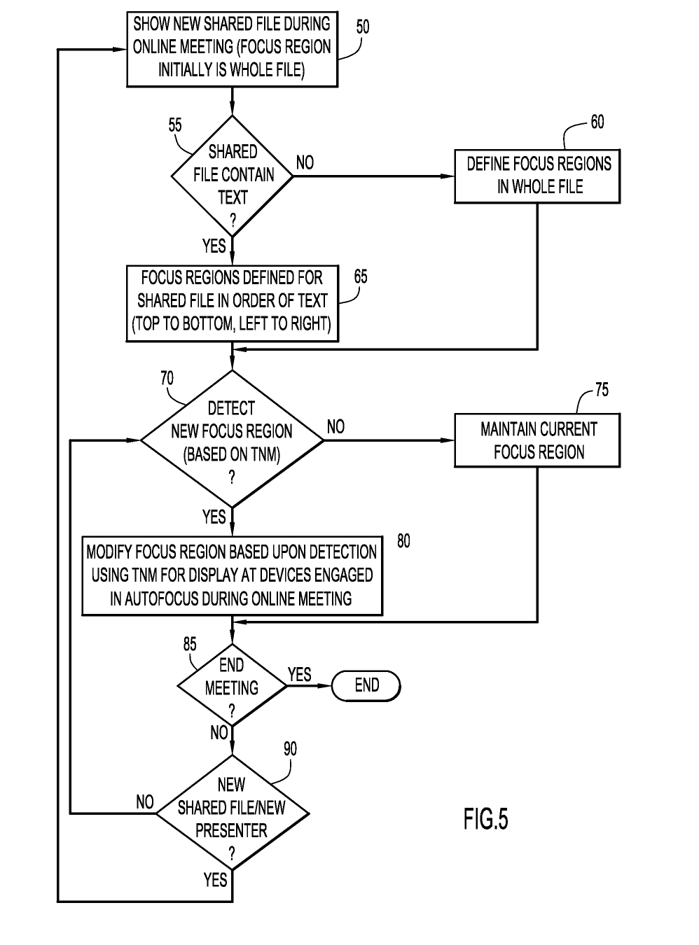

An example embodiment of a process for providing automatic enlargement or magnification of a focus region within shared content during an online meeting session between client devices 6 within the system 2 of FIG. 1 is described with reference to the flowchart of FIG. 5. Initially, it is noted that client devices 6 engage in the online meeting session that is hosted by at least one meeting server 20 over the network 4. At the start-up of the online meeting session, a presenter can initially be designated in any conventional or other suitable manner (e.g., first client device 6 to join in the online meeting session, or a presenter is designated during the meeting in any suitable manner). The meeting software application module 14 for each client device 6 includes one or more suitable software applications that enable user interaction at each client device 6, e.g., via a GUI (graphic user interface) that is presented by the display 16 of each client device 6. The GUI can be used to designate a particular client device 6 as a current presenter, where content to be shared originates from the presenter client device for viewing by all client devices engaged in the ongoing online meeting session. At any given time during the online meeting session, the designation of presenter can change or be switched from one client device 6 to another client device 6 engaged in the online meeting session. For example, a presenter at a first client device 6 designated as the current presenter may be finished speaking or presenting content from the first client device 6 in the online meeting session, and a user at a second client device 6 may then be designated the current presenter within the session to speak and present content from the second client device 6. The designation of a current presenter to a client device, and the switching of such presenter from one client device to another client device, within an online meeting session are generally known for online meeting platforms and are not described in any further detail herein.

Referring to the flow chart of FIG. 5, an online meeting session has been initiated and a current presenter is sharing content (e.g., showing a new shared file) at 50 with other client devices 6 engaged in the online meeting session. The TNM module 17 at the current presenter client device 6 determines, at 55, whether the shared file or other shared content contains text (e.g., whether the shared content may be a word processing document). The detection of text within shared content can be performed via any suitable text recognition software provided with the TNM module 17.

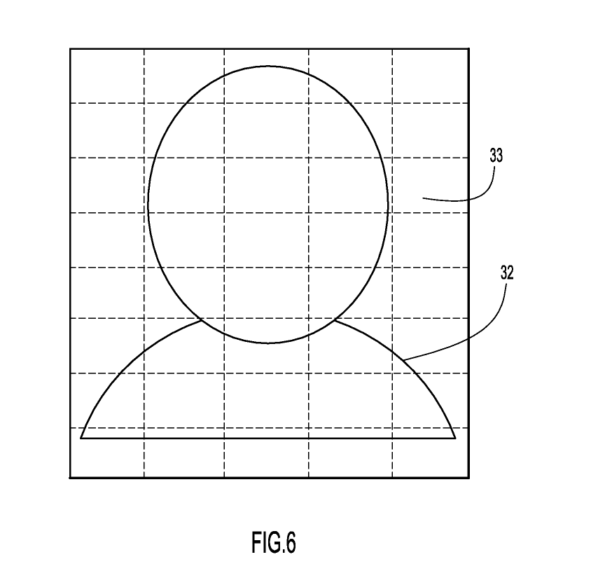

In the event the shared content is determined to not contain text (or a substantial or majority of the content is determined as not containing text), at 60 the focus region for the shared content is determined to remain the whole or entire file or content. For example, in the event the shared content is an image file, the focus region is initially set to be the entire area or region of the image file. An example embodiment of shared content 32 that is determined not to contain text (or an insignificant portion of text) is depicted in FIG. 6. The TNM module 17 can further define possible focus regions 33 within the shared content, where a particular focus region 33 can be selected for magnification in the event a detection of the navigator 7 for the presenter client device 6 determines there is sufficient navigator motion within such focus region as described herein.

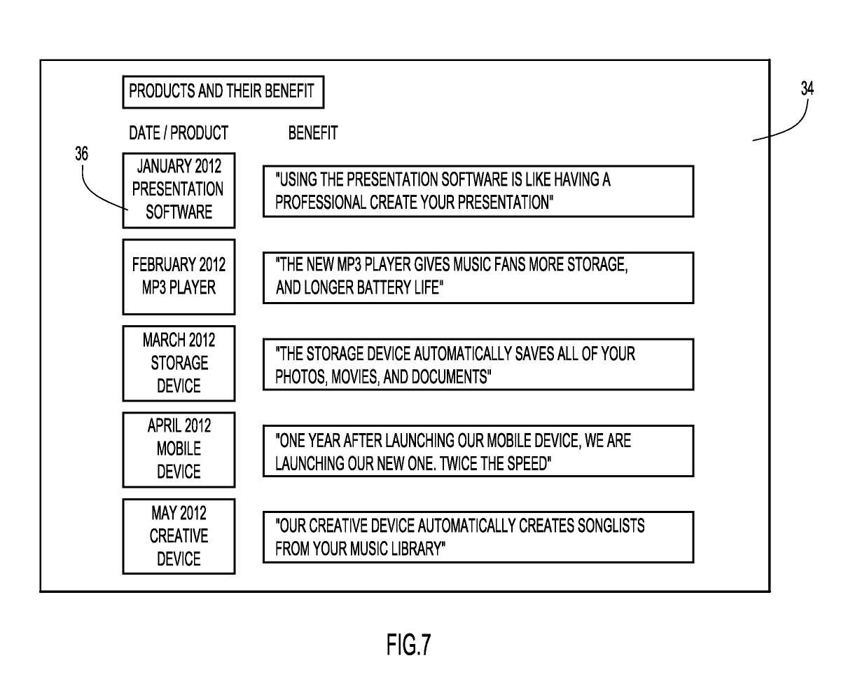

In the event a selected portion (e.g., a majority) of or the entire shared file or shared content is determined to contain text, possible focus regions are defined within the shared file or shared content at 65. In particular, possible focus regions can be defined based upon an order of the text, where the order can be from top to bottom and from left to right within the shared content. An example embodiment of a shared file 34 determined as containing text is depicted in FIG. 7. A series of blocks surrounding portions of content are defined (using the TNM module 17) as focus regions 36 within the shared file 34. Any suitable size for each focus region 36 can be selected. In an example embodiment, the focus regions 36 are selected so as to ensure adequate viewing and reading of the text when such focus regions are magnified for viewing by one or more mobile client devices 6.

It is noted that, when a new file or new content is initially shared by the presenter client device 6 with other client devices 6 within the online meeting session, the entire displayed content is designated the focus region. As previously noted, the focus region can be limited to defined focus regions containing text at 65 (and as depicted in FIG. 7). At 70, the TNM module 17 of the client device 6 designated as the current presenter detects whether to designate a new focus region. This is based upon the TNM module 17 monitoring movements of the icon (e.g., pointer, cursor, etc.) in relation to the shared content as controlled by the display icon navigator 7 of the presenter client device 6. For example, the presenter client device 6 can detect, via the TNM module 17, in any suitable manner whether the navigator 7 is controlling motion of the icon for a select period of time within a defined focus region, where the icon changes positions from a first location to one or more moved locations. The tracking of icon movements, based upon operation of the navigator 7 at the presenter client device 6, takes advantage of typical habits associated with presenters in online meeting sessions during sharing of content, where a presenter may consciously or subconsciously move the display icon via a mouse device or other navigator 7 to an area in the shared content to which the presentation is currently focused. Further, when a presenter has knowledge of the techniques described herein being implemented within an online conference session, the presenter may choose to take advantage of these techniques to focus the attention of other participants to a particular focus region by controlling the navigator 7 to move the icon (e.g., pointer, cursor, etc.) to the focus region of interest.

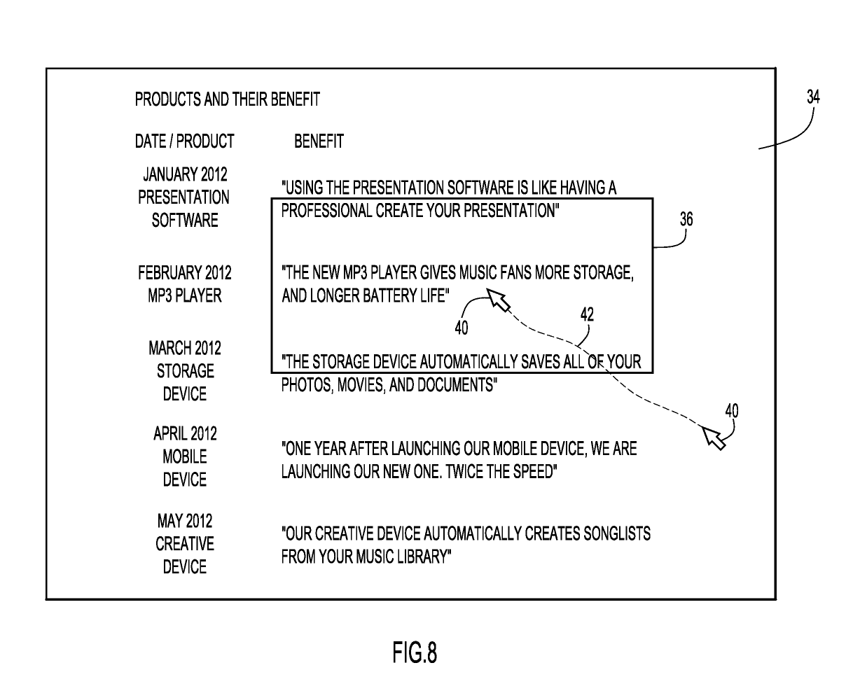

Examples of types of navigator detection that can be implemented utilizing the TNM module 17 are described with reference to FIGS. 8-10. In FIG. 8, a pointer 40 is shown displayed along with the shared content 34, where the pointer 40 is controlled by operation of the navigator 7 (e.g., a mouse device) at the presenter client device 6. The points at which the pointer 40 is moved in the area of the shared content 34 can be defined by a Cartesian coordinate system in which two-dimensional movements of the pointer by the navigator 7 are mapped as (x, y) coordinates within the area defined by the shared content or shared file. As depicted in FIG. 8, the presenter, using navigator 7, directs pointer 40 from a first location to a second location that is within a defined focus region 36, as traced along a navigation path 42. The presenter client device 6, using TNM module 17, monitors movements input by the navigator 7. In this embodiment, the movement of pointer 40 is tracked from the first location to the second location. Based upon such detected movement, and a detection that the pointer 40 remains at the second location, within the focus region 36, for a selected period of time, focus region 36 can be identified as a new focus region to be automatically modified at other client devices 6 that are engaged in the online meeting session.

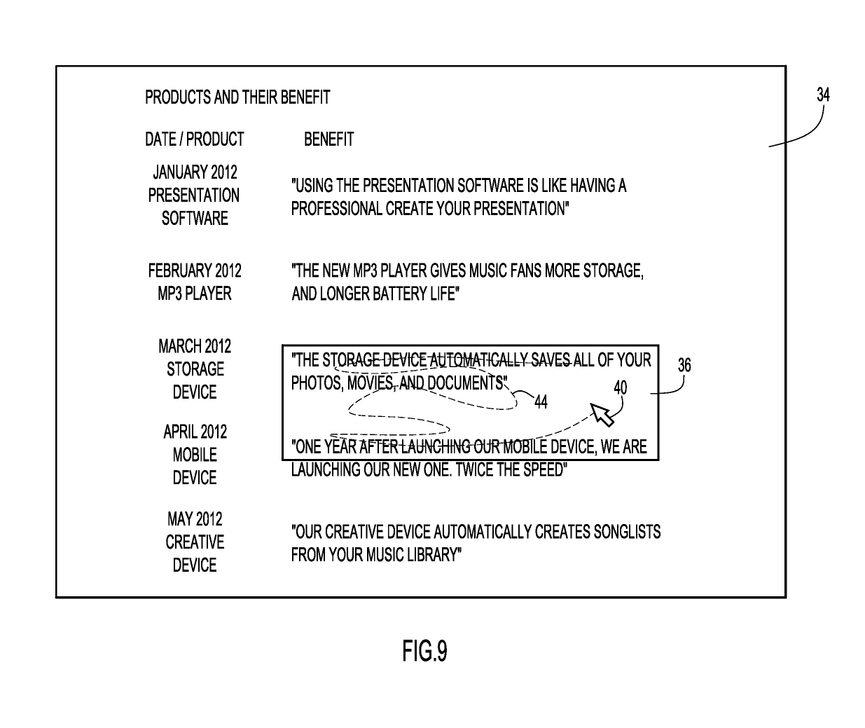

Another example depicting tracking of movements based upon operation of the navigator 7 at the presenter client device 6 is depicted in FIG. 9. In this example embodiment, the pointer 40, which is controlled by the navigator 7 at the presenter client device 6, has a detected motion path or trajectory as indicated by curved line 44. Based upon such detected motion, the presenter client device 6, using the TNM module 17, can determine that the pointer movements are within a defined focus region 36. Such movements (e.g., movements in a circle or irregular shape), as detected during a selected time period, can result in designating the defined focus region 36 to be automatically magnified at certain client devices 6 engaged in the online meeting session.

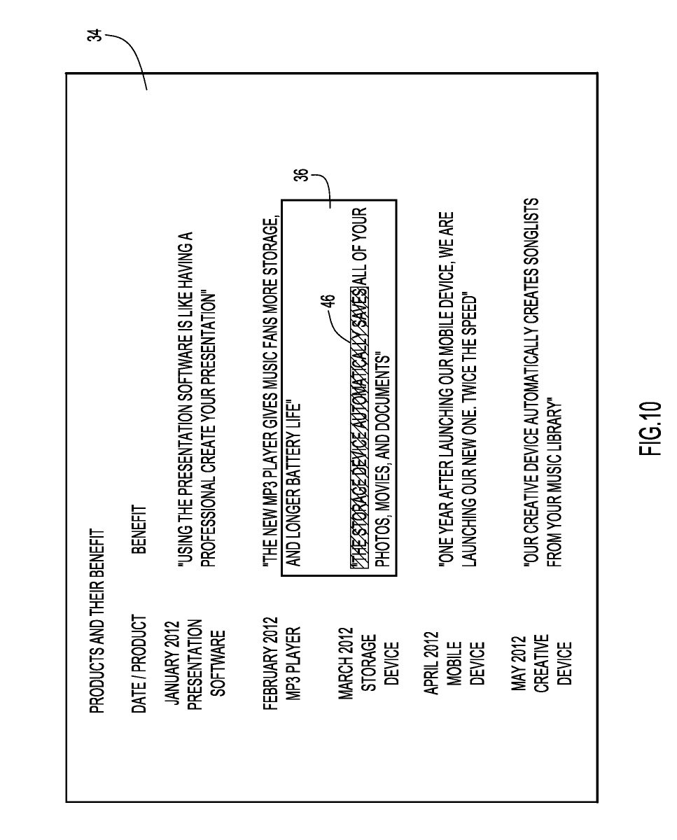

A further example depicting tracking of movements based upon operation of the navigator 7 at the presenter client device 6 is depicted in FIG. 10. In this example embodiment, the presenter may choose to highlight (via the navigator 7) a portion 46 of the shared content 34 within a defined focus region 34. The presenter client device 6 can detect, via the TNM module 17, operations by the navigator 7 that result in the highlighted portion 46 of shared content 34 and also its location within the defined focus region 36. This can result in the defined focus region 36 being designated to be automatically magnified at certain client device 6 engaged in the online meeting session.

The example embodiments depicted in FIGS. 8-10 for detecting tracking movements operated by the navigator 7 at the presenter client device 6 can be implemented separately or in combination with each other for determining a focus region to designate for automatic magnification within shared content for the online meeting session.

In addition, while the examples described herein designate defined focus regions for shared content (both for shared content detected as including text and other shared content, e.g., images) that are independent of navigator-controlled icon movements, and then the trajectories or movements of an icon (e.g., pointer, cursor, etc.) controlled by the navigator 7 are mapped within a particular defined focus region so as to determine which focus region to designate for automatic magnification, it is noted that other techniques for determining a focus region based upon movements of the icon controlled by the navigator 7 can also be utilized. For example, a focus region can be defined based upon the navigator-controlled coordinate (x, y) movements of the icon controlled by the navigator 7, where an area defined by icon movements (e.g., as depicted in FIG. 9) can be used to define a focus region, or a specified area surrounding a stopping point for the icon after its movement has been detected (e.g., as depicted in FIG. 8) can be used to define a focus region.

At 70, when there is no detected movement of the icon by the navigator 7 (e.g., a mouse device of the presenter client device 6 remains motionless during sharing of content), the initial focus region, which is defined as the whole area of the shared content, remains unchanged at 75.

However, when a new focus region is detected, based upon techniques such as those previously described in relation to FIGS. 8-10, the focus region is modified at 80 to the defined focus region that corresponds to the movements of the icon as tracked using the TNM module 17. The information regarding the modified focus region is communicated to other client devices 6 engaged in the online meeting session over the network 4. For client devices 6, such as mobile client devices 6, that have selected an auto-focus feature in which automatic magnification occurs based upon navigator controlled icon movements by the presenter within the shared content, the focus region is automatically magnified at such client devices 6 (e.g., an automatic adjustment from viewing content such as depicted in FIG. 4A to a focus region of viewing content as depicted in FIG. 4B, where the focus region is a magnified view of a smaller area within the entire area of the shared content).

At 85, in response to a determination that the meeting is still ongoing (i.e., meeting has not ended), a determination is made at 90 whether there is a new presenter and/or a new shared file or other new shared content. In response to a determination that the presenter remains unchanged, the process continues at 70 to detect whether a new focus region is to be magnified, based upon movements of the icon by the navigator 7 at the current presenter client device 6. If there is no detection of operation of the navigator 7 to move the icon (e.g., no movements made by the mouse device at the presenter client device 6, such that the pointer remains idle or at the same general location in relation to the current focus region), no change is made and the current focus region is maintained. In the event the icon has been moved using the navigator 7, the motion control and/or other actions associated with the icon are tracked (e.g., utilizing some or all of the techniques as described herein in relation to FIGS. 8-10) to determine whether a new focus region should be designated for auto magnification at selected client devices 6. The repeated process continues until a determination of a new presenter/new shared content or the meeting ends.

When a new presenter or new shared content is detected at 90, the process repeats again at 50. If new shared content is being shared with the same presenter, the navigator 7 of the same presenter client device 6 is monitored using the TNM module 17 of the same presenter client device 6. Alternatively, if a new presenter has been designated within the online meeting, the process continues at 50 via the shared content of the new presenter and by monitoring the navigator 7 of the new presenter client device 6 using the TNM module 17 at the new presenter client device 6.

One or more meeting server(s) 20 associated with an ongoing meeting session can also optionally include a TNM module 29 including one or more software programs to provide some of the monitoring features in relation to the navigator 7 of a presenter client device 6. For example, rather than designating the processing of all features of determining focus regions for shared content and tracking of movements of the icon in relation to the shared content at each presenter client device 6 (via the TNM module 17 at each presenter client device 6), one or more servers 20 (each utilizing its TNM module 29) can determine focus regions based upon information received from client devices that are designated as the current presenters. For example, input information from the navigator 7 of a client device 6 designated as a presenter when shared content is provided during an online meeting session can be utilized by a server 20 to determine a focus region for the shared content that corresponds with the input information of the navigator 7 (where such input information corresponds with movement of an icon to one or more locations within an area of the shared content). The server 20 can then use such information to determine whether a focus region is to be modified for magnification at client devices 6 engaged in the online meeting session. Thus, the processing associated with defining and assigning focus regions of shared content based upon detection of tracked movements of an icon (as determined by inputs from the navigator 7) associated with the presenter client device 6 can be handled by one or more servers 20 during the online conference instead of by the current presenter client device 6. It is noted, however, that the processing required to detect focus regions based upon icon motions as determined by navigator inputs from the presenter client device requires very little processing resources at the presenter side.

Automatic magnification of a designated focus region of shared content during an online meeting session can be implemented directly at certain client devices 6 engaged in the online meeting session. For example, client devices that are receiving the shared content during the online meeting session can further receive information regarding a focus region of the shared content to be magnified. Each client device 6 (e.g., utilizing its TNM module 17) can automatically display a magnified view of the focus region in response to receiving information regarding the focus region (or a modified focus region). The amount or degree of magnification can be selected (e.g., personalized) for each client device 6. Alternatively, a designated focus region can be automatically magnified at the presenter client device 6 and/or a meeting server associated with the online meeting session, and the magnified view of the focus region can be provided to client devices 6 engaged in the online meeting session.

The system 2 of FIG. 1 can also be configured to provide client devices 6 with the option (e.g., by selection via a GUI that provides interactive features and user control during an online meeting session) of choosing (e.g., turning on or turning off) the automatic magnification of a designated focus region for shared content in an online meeting session. For example, as previously noted herein, mobile devices (e.g., PDAs, cellular phones, etc.) that have smaller viewing display screens may find the automatic focus feature provided by the techniques described herein useful and thus choose to implement such features for online meetings including the sharing of content. However, a client device 6 that comprises a desktop PC or a laptop having a larger viewing display screen may choose to not implement such automatic focus feature. Alternatively, a client device 6 such as a desktop PC or laptop may also choose to implement the automatic focus feature for certain online meeting sessions, e.g., to ensure that content currently being discussed by a presented is at the focus of a user's attention during the meeting.

Thus, the techniques described herein provide an effective mechanism for accurately determining focus regions of shared content based upon presenter movements of a navigator controlled icon (e.g., pointer, cursor, etc.). This allows client devices, in particular mobile client devices having smaller display screens, to easily view and follow portions of shared content based upon automatic magnification of focus regions without having to make manual adjustments (e.g., the user can engage “hands free” in the meeting on their mobile device). Further, in scenarios in which only the focus region portion of the shared content is transferred to client devices, the amount of data associated with the shared content that needs to be transferred to client devices can be minimized, thus conserving network bandwidth consumption.

The above description is intended by way of example only.

What is claimed is:

1. A method comprising:
in an online meeting including a plurality of computing devices, wherein one of the computing devices is designated as a presenter, providing shared content from the presenter to at least one other computing device engaged in the online meeting;
detecting whether a display icon located within an entire area of the shared content and controlled via an icon navigation device at the presenter has moved from a first position to at least one moved position;
in response to a detection that the display icon has moved to the at least one moved position, determining a focus region of the shared content that corresponds with movements of the display icon, wherein the focus region comprises a defined smaller area of the shared content in relation to the entire area and encompasses the at least one moved position; and
providing an indication to automatically modify the shared content so as to magnify a view of the focus region at one or more computing devices engaged in the online meeting.

2. The method of claim 1, further comprising:
automatically magnifying the focus region for display at each computing device engaged in the online meeting that has authorized an auto focus feature for the online meeting.

3. The method of claim 2, further comprising:
in response to a detection that the display icon has moved to a further position that is not defined within the determined focus region, determining a second focus region that corresponds with movement of the display icon to the further position, the second focus region comprising a defined smaller area of the shared content in relation to the entire area and encompasses the further position; and
providing an indication to automatically modify the shared content so as to magnify a view of the second focus region for display at each computing device engaged in the online meeting that has authorized an auto focus feature for the online meeting.

4. The method of claim 2, wherein the automatic magnifying of the focus region is implemented by the presenter such that each computing device engaged in the online meeting that has authorized the auto focus feature for the online meeting receives the focus region of shared content at the automatic magnification.

5. The method of claim 2, wherein each computing device engaged in the online meeting that has authorized the auto focus feature for the online meeting receives the entire area of shared content such that the automatic magnifying of the focus region is implemented at each computing device.

6. The method of claim 1, further comprising:
defining a plurality of focus regions for the shared content independent of detected motion of the display icon.

7. The method of claim 1, further comprising:
defining the focus region based upon detected movement of the display icon from the first position to the at least one moved position.

8. An apparatus comprising:
a memory configured to store instructions including one or more applications that support online meetings with other computing devices over a network;
an icon navigation device to control movements of a display icon within one or more applications displayed by the apparatus;
a network interface unit configured to enable communications over a network; and
a processor configured to execute and control operations of the one or more applications so as to:
when the apparatus is designated at a presenter of an online meeting, provide shared content from the apparatus to at least one other computing device engaged in the online meeting;
detect whether the display icon located within an entire area of the shared content and controlled via the icon navigation device at the apparatus has moved from a first position to at least one moved position;
in response to a detection that the display icon has moved to the at least one moved position, determine a focus region of the shared content that corresponds with movements of the display icon, wherein the focus region comprises a defined smaller area of the shared content in relation to the entire area and encompasses the at least one moved position; and
provide an indication to automatically modify the shared content so as to magnify a view of the focus region at the at least one other computing device engaged in the online meeting.

9. The apparatus of claim 8, wherein the processor is further configured to execute and control operations of the one or more applications so as to:
control an automatic magnification of the focus region for display at each computing device engaged in the online meeting that has authorized an auto focus feature for the online meeting.

10. The apparatus of claim 9, wherein the processor is further configured to execute and control operations of the one or more applications so as to:
in response to a detection that the display icon has moved to a further position that is not defined within the determined focus region, determine a second focus region that corresponds with movement of the display icon to the further position, the second focus region comprising a defined smaller area of the shared content in relation to the entire area and encompasses the further position; and
provide an indication to automatically modify the shared content so as to magnify a view of the second focus region for display at each computing device engaged in the online meeting that has authorized an auto focus feature for the online meeting.

11. The apparatus of claim 9, wherein the processor is configured to control an automatic magnification of the focus region by automatically magnifying the focus region at the apparatus such that each computing device engaged in the online meeting that has authorized the auto focus feature for the online meeting receives the focus region of shared content at the automatic magnification.

12. The apparatus of claim 8, wherein the processor is further configured to execute and control operations of the one or more applications so as to:
define a plurality of focus regions for the shared content independent of detected motion of the display icon.

13. The apparatus of claim 8, wherein the processor is further configured to execute and control operations of the one or more applications so as to:
define the focus region based upon detected movement of the display icon from the first position to the at least one moved position.

14. One or more computer readable storage media encoded with software comprising computer executable instructions and when the software is executed operable to:
in an online meeting including a plurality of computing devices, wherein one of the computing devices is designated as a presenter, provide shared content from the presenter to at least one other computing device engaged in the online meeting;
detect whether a display icon located within an entire area of the shared content and controlled via an icon navigation device at the presenter has moved from a first position to at least one moved position;
in response to a detection that the display icon has moved to the at least one moved position, determine a focus region of the shared content that corresponds with movements of the display icon, wherein the focus region comprises a defined smaller area of the shared content in relation to the entire area and encompasses the at least one moved position; and
provide an indication to automatically modify the shared content so as to magnify a view of the focus region at one or more computing devices engaged in the online meeting.

15. The computer readable storage media of claim 14, wherein the instructions are further operable to:
automatically magnify the focus region for display at each computing device engaged in the online meeting that has authorized an auto focus feature for the online meeting.

16. The computer readable storage media of claim 15, wherein the instructions are further operable to:
in response to a detection that the display icon has moved to a further position that is not defined within the determined focus region, determine a second focus region that corresponds with movement of the display icon to the further position, the second focus region comprising a defined smaller area of the shared content in relation to the entire area and encompasses the further position; and
provide an indication to automatically modify the shared content so as to magnify a view of the second focus region for display at each computing device engaged in the online meeting that has authorized an auto focus feature for the online meeting.

17. The computer readable storage media of claim 15, wherein the instructions are operable such that the automatic magnifying of the focus region is implemented by the presenter and each computing device engaged in the online meeting that has authorized the auto focus feature for the online meeting receives the focus region of shared content at the automatic magnification.

18. The computer readable storage media of claim 15, wherein the instructions are operable such that each computing device engaged in the online meeting that has authorized the auto focus feature for the online meeting receives the entire area of shared content and the automatic magnifying of the focus region is implemented at each computing device.

19. The computer readable storage media of claim 14, wherein the instructions are further operable to:
define a plurality of focus regions for the shared content independent of detected motion of the display icon.

20. The computer readable storage media of claim 14, wherein the instructions are further operable to:
define the focus region based upon detected movement of the display icon from the first position to the at least one moved position.
